(19) United States
(12) Patent Application Publication
(10) Pub. No.: US 2001/0003396 A1
(43) Pub. Date: Jun. 14, 2001

(54) TAMPER EVIDENT SEAL

(76) Inventor: NICHOLAS ERNEST FARREN, STAUNTON-IN-THE-VALE (GB)

Correspondence Address: ERIC B MEYERTONS, CONLEY ROSE & TAYON, PO BOX 398, AUSTIN, TX, 787670398

(21) Appl. No.: 09/117,463

(22) PCT Filed: Jan. 30, 1997
(86) PCT No.: PCT/GB97/00273

§ 371 Date: None

(30) Foreign Application Priority Data
Jan. 30, 1996 (GB) 9601860.1
Apr. 17, 1996 (GB) 9607967.8

(51) Int. Cl. B42D 15/00

(52) U.S. Cl. 283/71; 283/81

(57) ABSTRACT

A tamper evident seal for applying to an envelope having a first face closed by a flap and a second face, the seal comprising a strip having a first panel joined to a second panel by a fold line, each panel having a first side and a second side, the first side of each panel bearing adhesive and the second side of a panel bearing indicia showing that postage has been paid, the arrangement being such that in use a panel adheres to each face of the envelope with a panel overlying the flap.

This invention relates to a tamper evident seal for showing whether an envelope has been tampered with.

According to the invention there is provided a tamper evident seal for applying to an envelope having a first face closed by a flap and a second face, the seal comprising a strip having a first panel joined to a second panel by a fold line each panel having a first side and a second side, the first side of each panel bearing adhesive and the second side of a panel bearing indicia showing that postage has been paid, the arrangement being such that in use a panel adheres to each face of the envelope with a panel overlying the flap.

Embodiments of the invention will be illustrated by way of non-limiting example by reference to the accompanying figures of which:

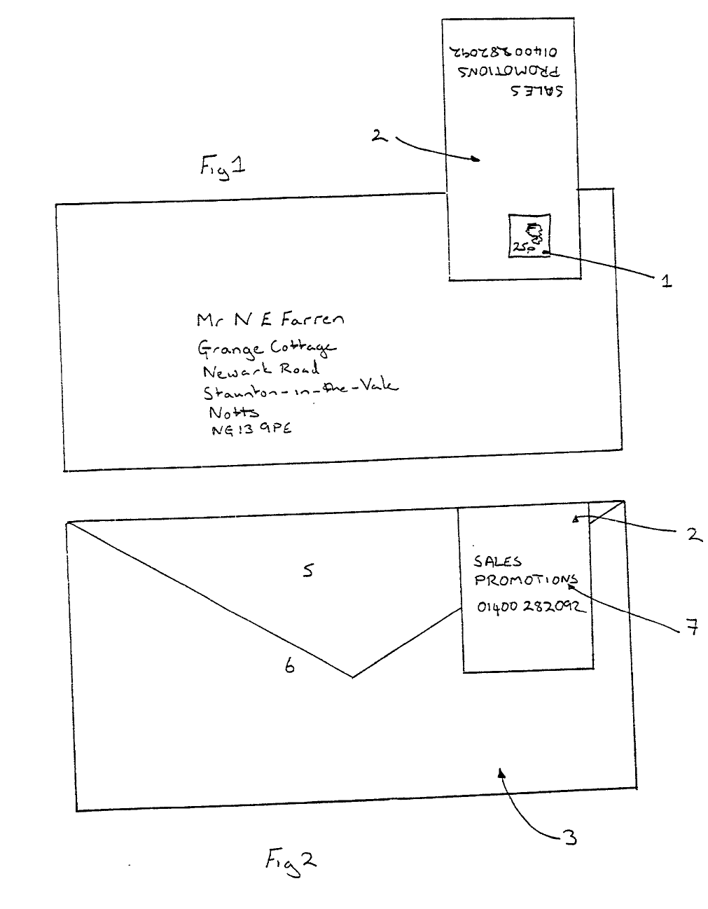

FIG. 1 is a front view of an envelope together with the seal of the invention;

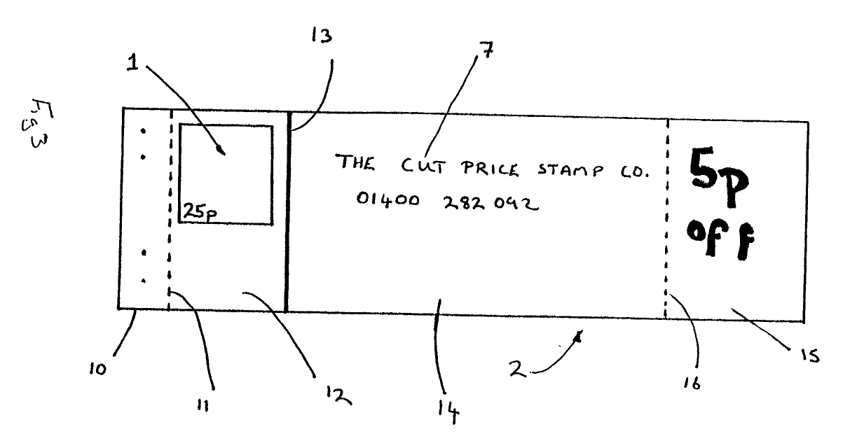

FIG. 2 is a rear view of the assembly of FIG. 1; and

FIG. 3 is a front view of a second embodiment.

A conventional post paid postage stamp is secured to strip 2. Preferably the stamp 1 is irreversibly secured to the strip 2 but it is within the scope of the invention for the stamp 1 to be secured to the strip by the water soluble adhesive commonly found on the back of postage stamps. It is not essential for a postage stamp to be used. Other indicia such as franking marks acceptable to the Post Office could be used.

The opposite face of the strip 2 is then secured to the sealed envelope 3. Preferably a pressure sensitive adhesive is used to secure the strip 2 to the envelope 3. Conveniently the adhesive is carried on the strip 2 and protected prior to use by a release strip (not shown).

The strip 2 is folded so as to at least partially cover the joint between the flap 5 and the body of the envelope 6.

Attempts to open the flap will result in the strip 2 being disturbed and thus it will be evident that the envelope has been tampered with.

One or more of the stamp bearing face of the strip, the opposite face of the strip and the release strip may bear indicia 7. Indicia 7 could comprise instructions on the use of the invention. Indicia 7 could comprise advertising or promotional material or photographs of missing persons. Indicia 7 could be in machine readable form such as bar codes or magnetic stripes. Indicia 7 could include holograms.

Commercial organisations using the invention to seal their mail could promote themselves. Retail outlets however might offer the items at or even below the face value of the stamp. The incentive for the purchaser is clear in that he obtains the device of the invention free or is paid to have it. The advertiser gains a benefit since his advertisement is likely to be read at least once.

A particular preferred embodiment is shown in FIG. 3. A book of strips 2 is provided with stubs 10 joined by for example stapling or gluing. The book may have covers. A frangible link for example perforations 11 allows a strip 2 to be separated from stub 10 and hence the book stamp 1 is carried on a first panel 12 intended to be mounted on the front of the envelope 6. To facilitate folding of the strip 2 about the envelope a fold line 13 for example a score mark is provided to define a border between the first panel 12 and a second panel 14. Second panel 14 carries indicia 7 such as advertisements. A third panel 15 is joined to the strip 2 by frangible link 16. Third panel 15 comprises a discount voucher for goods or services. Additionally the release strip may function as a discount voucher or bear other indicia such as advertisements.

Second or third panels may be adapted to be mounted on a card or other member for example for sales promotions where discounts, goods or services are offered in exchange for a card filled with discount vouchers. Second or third panels may be adapted to adhere to other objects.

In addition to the advantages set forth above the invention has the merit that the postage stamp is mounted on a larger object which means that it is less likely to be mislaid than an ordinary stamp and is easier for those of limited manual dexterity, for example, people suffering from arthritis to use.

In some embodiments of the invention security coding could be provided. This could take the form of alphanumeric codes or holograms and could be provided anywhere on the invention but most conveniently on a panel, release strip or cover. Other security coding such as bar codes or holograms could be used. In one embodiment of the invention the security coding users genetically coded material such as nucleic acids.

In some embodiments of the invention portions containing crome released by scratching may be provided. Typically but not essentially they will be provided in association with indicia promoting cosmetics or food stuffs.

The panels need not be rectangular as shown. For example, a panel could be star shaped, round or square.

1. A tamper evident seal for applying to an envelope having a first face closed by a flap and a second face, the seal comprising a strip having a first panel joined to a second panel by a fold line each panel having a first side and a second side, the first side of each panel bearing adhesive and the second side of a panel bearing indicia showing that postage has been paid, the arrangement being such that in use a panel adheres to each face of the envelope with a panel overlying the flap.

2. A seal as claimed in claim 1 wherein the indicia is a postage paid postage stamp.

3. A seal as claimed in claim 1 wherein the adhesive is a pressure sensitive adhesive protected by a release strip.

4. A seal as claimed in any one of the preceding claims wherein one or more of the sides of one or more of the panels or one or more sides of the release strip, bear promotional indicia.

5. A book of tamper evident seals for applying to an envelope comprising a plurality of seals as claimed in any one of the preceding, each seal having a stub joined to the first panel by a frangible link, the stubs being bound together.

6. A book of tamper evident seals as claimed in claim 4 wherein a third panel bearing promotional indicia joined to the second panel by a frangible link is provided.

7. A book of tamper evident seals as claimed in claim 4 or claim 5 wherein a frangible link comprises perforations.
